(19) United States
(12) Patent Application Publication
(10) Pub. No.: US 2012/0061534 A1
(43) Pub. Date: Mar. 15, 2012

(54) QUICK FASTENING DEVICE

(75) Inventor: Daniel Rehage, Bielefeld (DE)

(73) Assignee: Paul Hettich GMBH & Co. KG, Kirchlengern (DE)

(21) Appl. No.: 13/254,475

(22) PCT Filed: Mar. 3, 2010
(86) PCT No.: PCT/EP2010/052707

§ 371 Date: Nov. 15, 2011

(30) Foreign Application Priority Data
Mar. 6, 2009 (DE) 20 2009 003 045.8

(51) Int. Cl. A47B 96/06; F16B 2/06

(52) U.S. Cl. 248/214

(57) ABSTRACT

The invention relates to a quick fastening device for fastening a guide rail (6) to a horizontally extending rod (3), which comprises one bent end section (4) at each opposite side, wherein the end sections are fixed to posts (2) of a grate-like side part (1), wherein at least one bent end section (4) is encompassed by a clamp (10, 20, 20′, 30, 30′, 40, 50, 60, 60′, 70, 80) that is connected to the guide rail (6), wherein a stop (12, 17, 17′, 31, 31′, 42, 51, 64, 64′ 72, 82) lying against a post (2) on the side facing the guide rail (6) is formed on at least one clamp (10, 20, 20′, 30, 30′, 40, 50, 60, 60′, 70, 80).

The present invention relates to a quick fastening device for fastening a guide rail to a horizontally extending rod which comprises one bent section at each opposite side, which end sections are fixed to posts of a grid-like side part, wherein at least one bent end section is encompassed by a clamp connected to the guide rail.

WO 2007/074114 discloses a quick fastening device for fastening a guide rail of a pull-out guide to a grid-like side part. For this purpose, the horizontal rod is encompassed in a bent end region by a clip-type retaining section so that the two retaining sections can be slid in one direction parallel to the bent end sections. This enables easy assembly but the guide rails of the pull-out guide usually protrude into the interior of a household appliance adjacent to the horizontal rod.

WO 2007/090738 discloses a quick fastening for a guide rail, in which two clip-like retaining elements are provided, which can be slid onto the bent end sections in one direction parallel to the longitudinal direction of the rod. As a result, assembly can be accomplished in a simple manner on a front side. Here also the clip-type retaining sections do not only encompass the bent end section but also the region of a rod running in the longitudinal direction so that the structure is relatively large towards the inside.

It is therefore the object of the present invention to provide a quick fastening device for fastening a guide rail to a horizontally extending rod and/or a vertically extending post, which has a compact structure and enables a simple fastening of the guide rail. This object is solved with a quick fastening device having the features of claim 1.

According to the invention a stop lying against a post on the side facing the guide rail is formed on at least one clamp so that the stop forms a securing means against displacement of the quick fastening device in the direction of the post. It is thereby achieved that the fastening points on the region of the longitudinal extension of the rod can be omitted and the fastening is disposed closer to the post, i.e., on an outer wall of an inner compartment since the side grid with the rods is usually fixed on a side wall of an inner compartment, in particular in a baking oven. The usable interior space is thereby enlarged and the guide rail of the pull-out guide can be positioned further outwards.

Preferably a stop for abutting against a post on the side facing the guide rail is formed on both clamps so that under loading of the guide rail towards the post a supporting is accomplished at both clamps and a pivoting movement of the quick fastening device is prevented. The stop can optionally be configured to be plate-shaped and form a plane stop surface on a U-shaped holder. The U-shaped holder has the advantage that not only forces can be transmitted in the direction of the post but tensile forces of the guide rail can also be absorbed by the post through the U-shaped holder. This requires that the U-shaped holder can be inserted with one leg between the post and the side wall, for example, of a baking oven.

For a stable fastening of the quick fastening means, a clamp is fixed on the bent end section of a rod by means of latching means. The latching means can be formed by bendable webs on a clamp so that easy assembly is ensured.

For a simple fixing of the quick fastening device at least one clamp comprises two U-shaped receptacles disposed at an angle to one another. As a result, these clamps can be simply mounted by inserting a bent end section or the post into a first receptacle and then pivoting in such a manner that the second U-shaped receptacle engages with a bent end section or the post, where the clamp has a minimal material requirement since the clamps can be configured in a particularly compact and material-saving manner by forming two U-shaped receptacles.

For easy assembly of both clamps on the guide rail, both clamps can be fixed on a strip which is connected to the guide rail. As a result, both clamps can be pre-assembled on the strip so that only one fastening step is required, i.e. fixing the strip on the guide rail. Alternatively it is also possible to form the clamps integrally with the guide rail so that an additional strip can be dispensed with. A further alternative constitutes the direct fixing of the clamps on the guide rail. This can be accomplished, for example, by a positive or firmly bonded connection.

For a compact arrangement of the guide rail on the side grid the guide rail is disposed at least partially above the rod so that by the quick fastening device the guide rail is not positioned next to a horizontal rod but above so that the usable interior space of a baking oven or other household appliance is enlarged. Ideally the same food racks can be used which could be inserted into the side grid before mounting the pull-out guide on the side grid. Consequently, in the fastening arrangement according to the invention, pull-out guides can easily be retrofitted for increasing the comfort. The user can reuse the same food racks.

The latching means preferably encompass the rod or the post over more than half the diameter so that a secure hold is ensured. The rod or the post is usually configured to be circular in cross-section so that the latching means project by half or more to the rod or the post and ensure a secure fixing.

The invention is explained in detail hereinafter by means of a plurality of exemplary embodiments with reference to the appended drawings. In the figures:

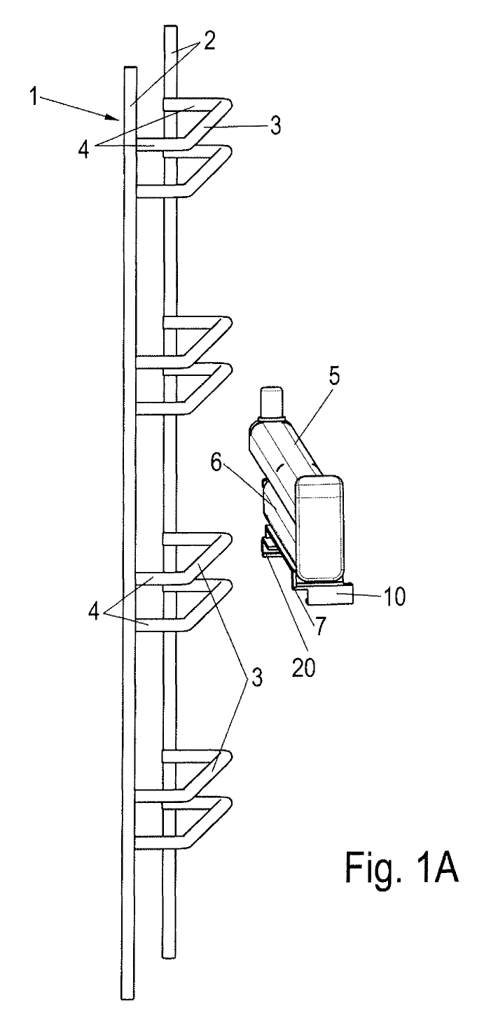

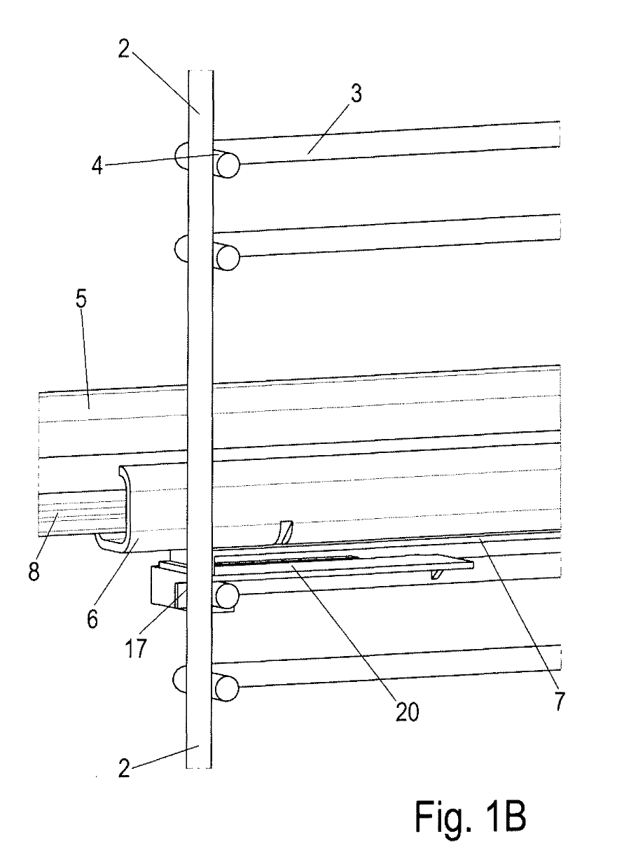

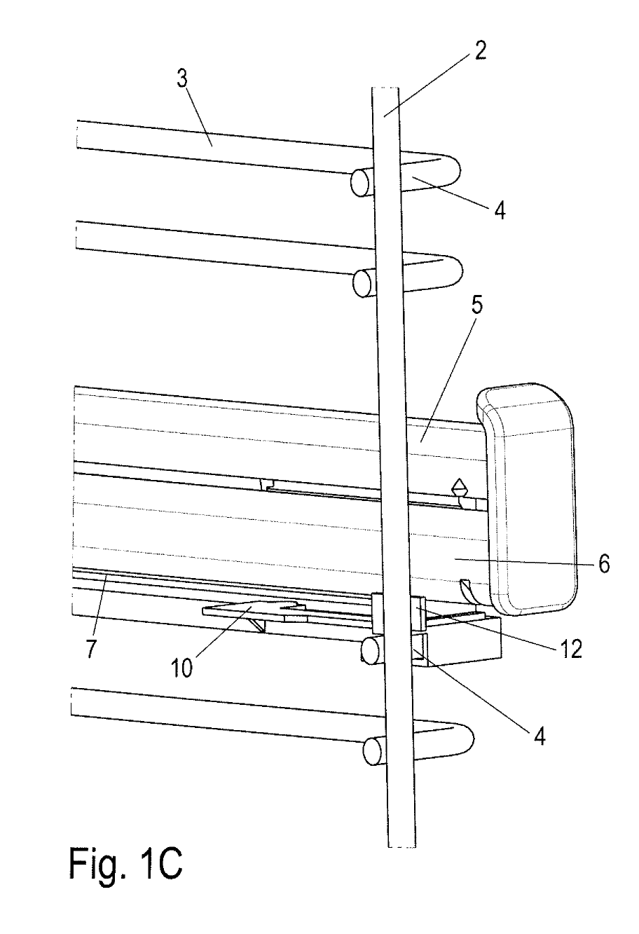

FIGS. 1A to 1C show several views of a quick fastening device according to a first exemplary embodiment during assembly;

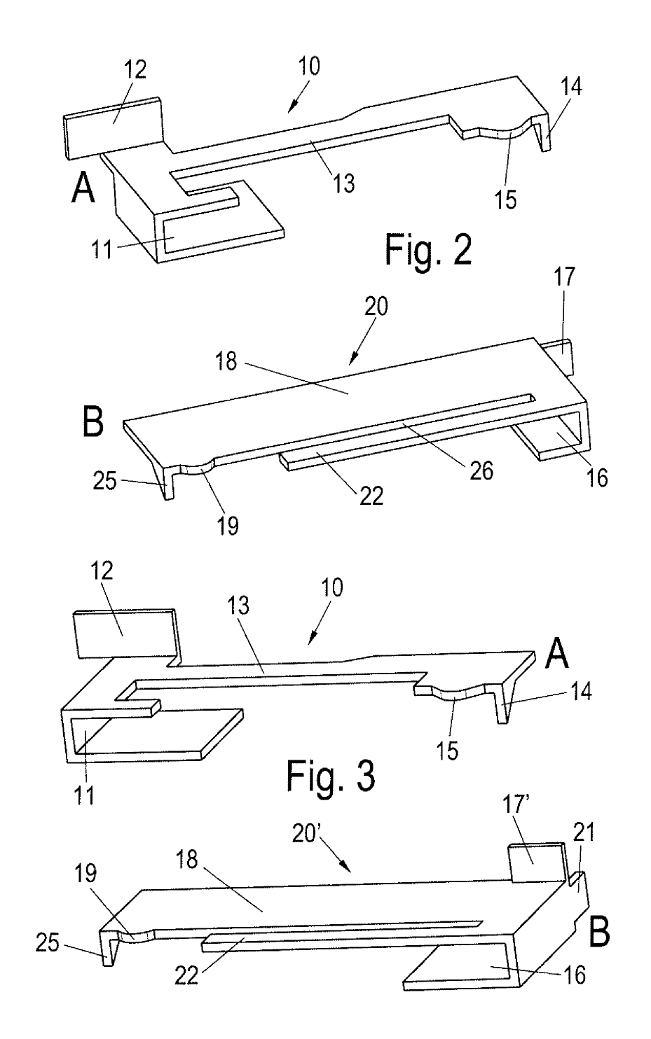

FIGS. 2A and 2B show two views of the clamps of the quick fastening device from FIG. 1;

FIGS. 3A and 3B show two views of a modified embodiment of clamps of a quick fastening device;

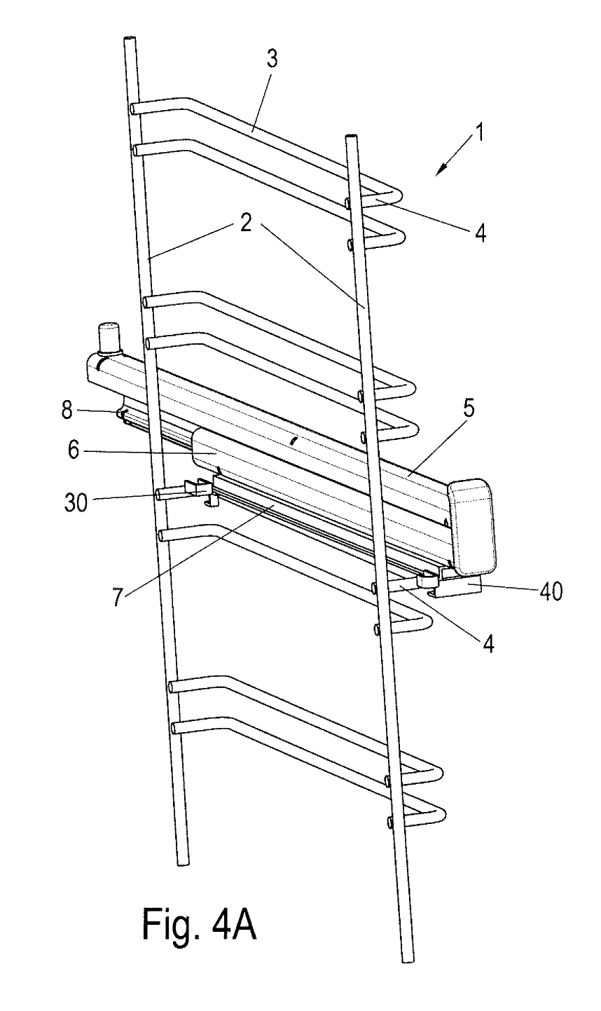

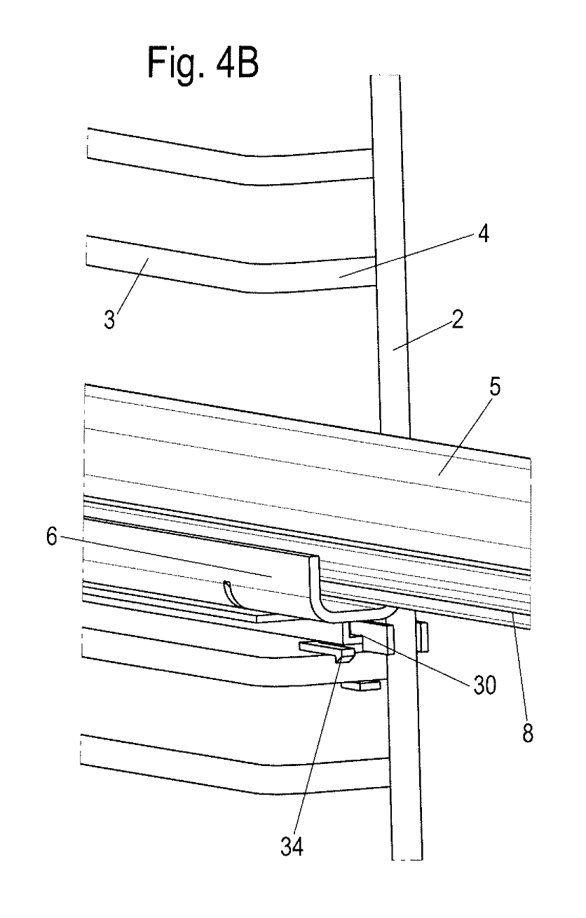

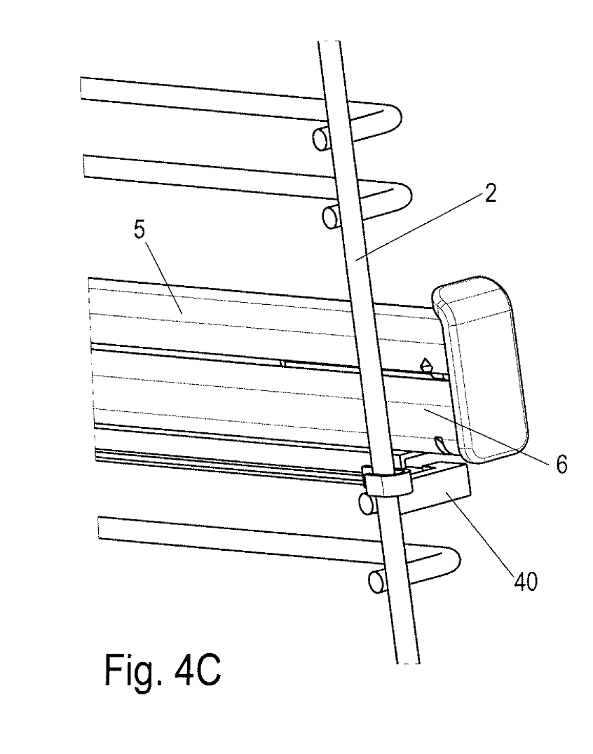

FIGS. 4A to 4C show several views of a further embodiment of a quick fastening device according to the invention during assembly;

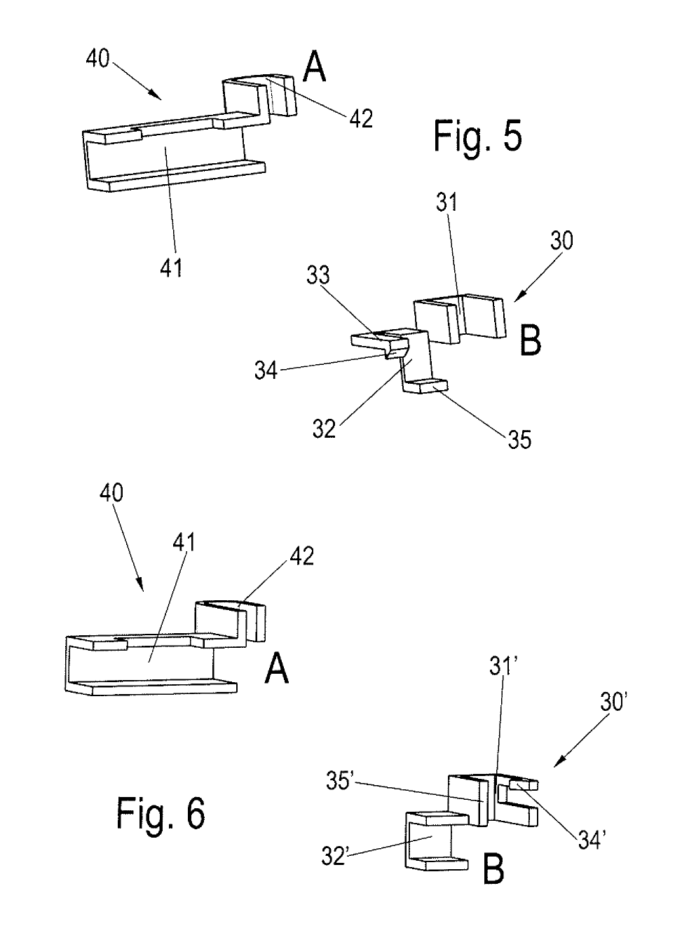

FIGS. 5A and 5B show two views of the clamps of the quick fastening device from FIG. 4;

FIGS. 6A and 6B show two views of modified clamps of a quick fastening device;

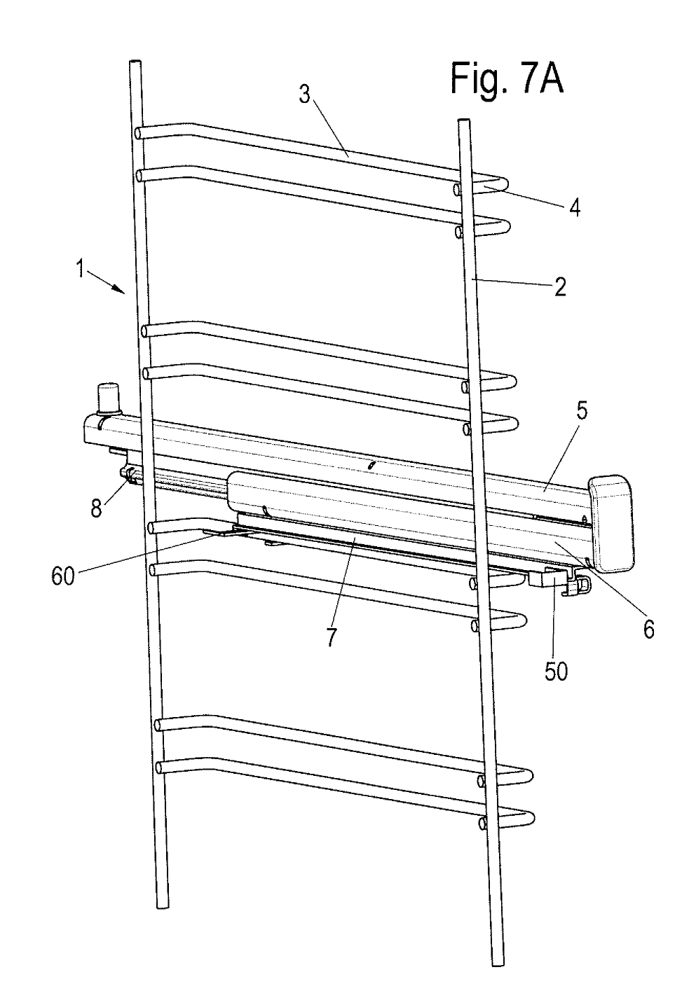

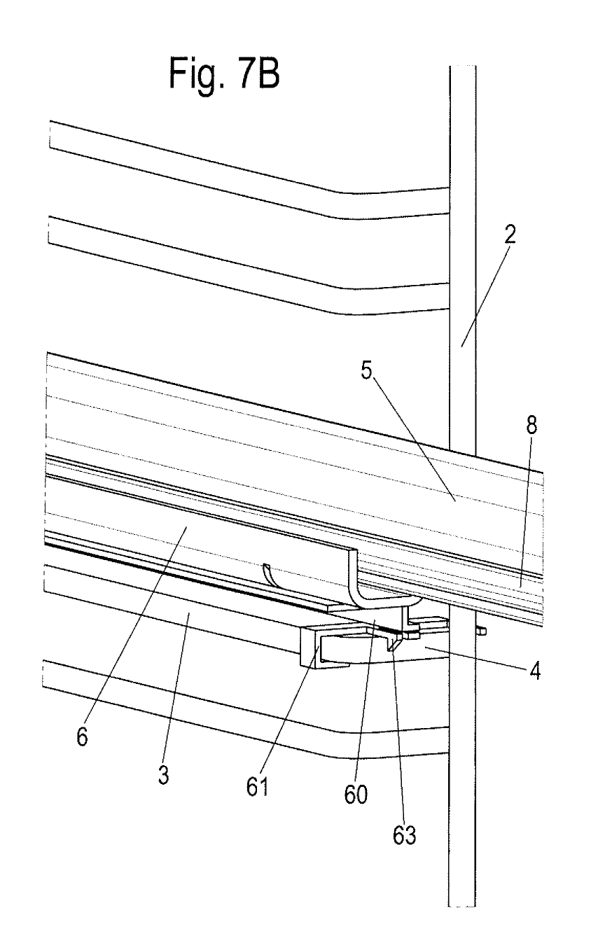

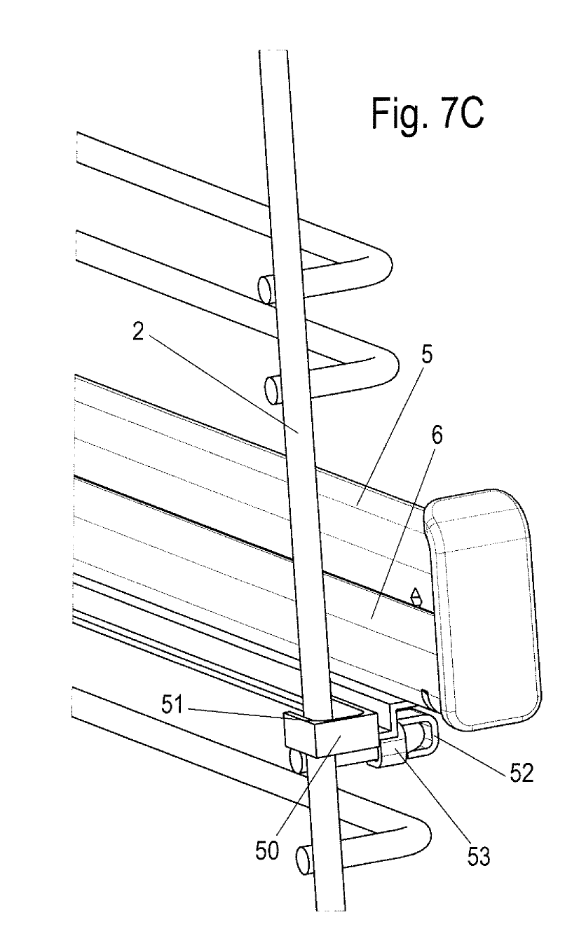

FIGS. 7A to 7C show several views of a further embodiment of a quick fastening device during assembly;

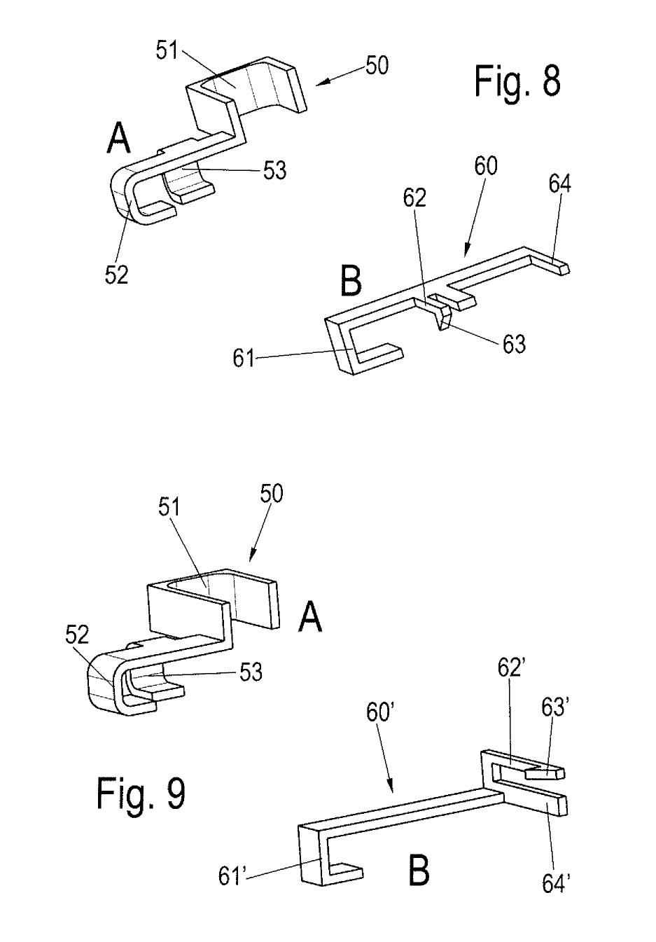

FIGS. 8A and 8B show two views of the clamps of the quick fastening device from FIG. 7;

FIGS. 9A and 9B show two views of a modified embodiment of the clamps of a quick fastening device;

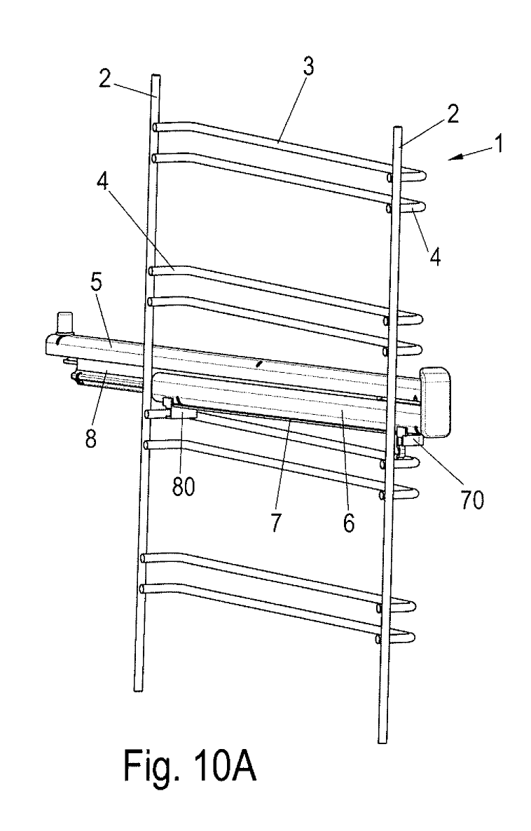

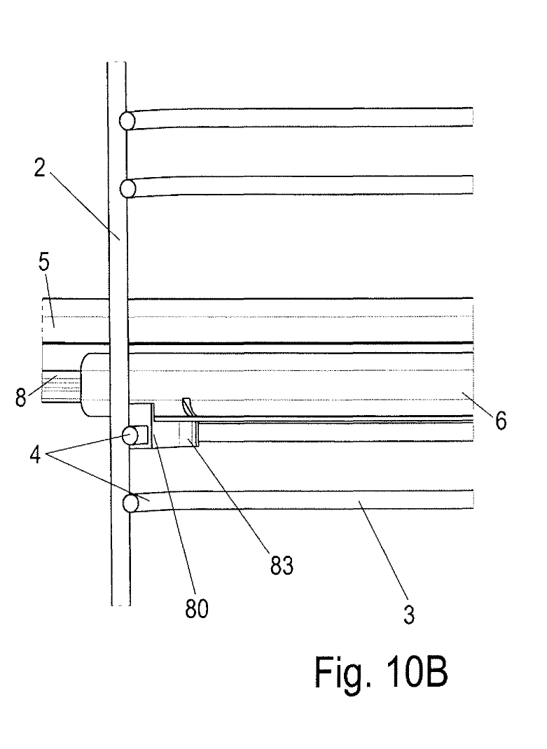

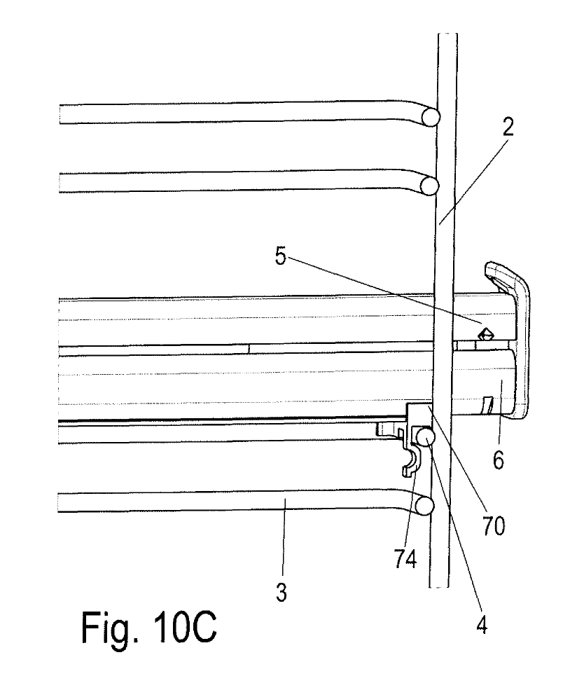

FIGS. 10A to 10C show several views of another embodiment of a quick fastening device during assembly; and

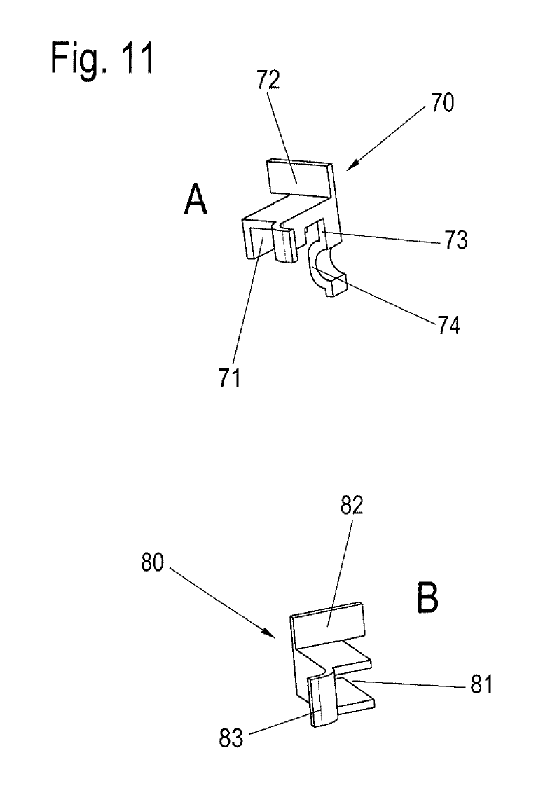

FIGS. 11A and 11B show two views of the clamps of the quick fastening device from FIG. 10.

A quick fastening device for fixing a pull-out guide on a side grid 1 is used in particular for baking ovens but can also be used for other household appliances or in the furniture area.

The side grid 1 comprises two vertical posts 2 on which a plurality of horizontal rods 3 are fixed. The rods 3 are each arranged in pairs but other forms of a side grid 1 are also possible. Each horizontal rod 3 comprises a middle section which extends in the longitudinal direction of the rod 3 and bent end sections 4 are provided on opposite sides, which run substantially at right angles to the longitudinal direction. The end sections 4 are fixed on the posts 2 at the ends, for example, by weld spots.

Two clamps 10 and 20 which are fixed on a strip 7 are provided for assembling a pull-out guide. The strip 7 is fixed on a guide rail 6 of the pull-out guide on which one or more running rails 5 are movably mounted by means of rolling bodies. In addition, a pull-out lengthening middle rail 8 is located between the guide rail 6 and the running rail 5 which is also mounted by means of rolling bodies. In this case a first clamp 10 encompasses an end section 4 on a front side of the side grid 1 and the second clamp 20 encompasses a rear end section 4 on a rear-side area of the side grid 1.

The rear clamp 20 comprises a U-shaped receptacle 16 on which a plate-shaped stop 17 is formed. The bent end section 4 is inserted in the U-shaped receptacle 16 whilst the plate-shaped stop 17 abuts against the vertical post 2.

The front clamp 10 also comprises a U-shaped receptacle 11 for insertion of the bent section 4, where a plate-shaped stop 12 rests adjacently on the front post 2.

The quick fastening device with the clamps 10 and 20 is assembled by sliding the clamps 10 and 20 in the horizontal direction onto a rod 3 until the clamps 10 and 20 engage by gripping behind the projections 14 or 25 behind the rod 3 at the side grid 1.

As shown in FIGS. 2A and 2B, the front clamp 10 comprises a U-shaped receptacle 11 for the bent end section 4 and a plate-shaped stop 12 for abutting against a post 2. Furthermore, a bendable web 13 is provided on which a bent projection 14 is disposed at the end. The projection 14 grips behind the rod 3 in a longitudinal region whilst a support 15 formed on the web 13 abuts against the upper side of the rod 13 in the area of the longitudinal extension. The clamps 10 thereby ensure a secure holding of the guide rail 6 by supporting in different directions.

The rear clamp 20 also comprises a U-shaped receptacle 16, on which a plate-shaped stop 17 is configured adjacently for abutment against a post 2. At the rear clamp 20 a web 22 is fixed on the strip 7, where an adjacent plate 18 is spaced apart by a slot 26 in the longitudinal direction of the rod 3 and is thereby bendable. On the side opposite the receptacle 16 the plate 18 comprises a downwardly directed projection 25 which grips behind a rod 3 and abuts against this. Furthermore, a support 19 is provided, which abuts against an upper region of the rod 3 so that the clamp 20 ensures a transfer of forces from the strip 7 to the side grid 1 and forces are transferred in different directions by corresponding stop faces.

FIGS. 3A and 3B show two clamps 10 and 20′ which are used in a modified quick fastening device. The clamp 10 corresponds to the first exemplary embodiment whilst the clamp 20′ has a difference adjacent to the U-shaped receptacle 16. Unlike in the preceding exemplary embodiment, the plate-shaped stop 17 is not formed as an extension of the plate 18 but projects vertically upwards as a plate-shaped stop 17′. In addition, another stop in the form of a plate 21 is formed on the side facing the post 2, which is disposed as an extension of the receptacle 16. As a result, the plate 21 can abut laterally against the post 2 so that a fastening is achieved by sliding the clamp 20′ in the horizontal direction parallel to the bent end sections 4 although the receptacle 16 does not abut or must not abut against the end section 4 with its base in the pull-out direction.

FIGS. 4A to 4C show another embodiment of a quick fastening device which is mounted on a side grid 1. The quick fastening device comprises a front clamp 40 and a rear clamp 30 which can be pushed onto a rod 3 from a front side. The appurtenant clamps 40 and 30 are shown in FIGS. 5A and 5B.

The front clamp 40 comprises a U-shaped receptacle 41 which can be pushed around the bent end section 4 of the rod 3 located at the front. Another U-shaped receptacle 42 is further formed on the clamp 40, which is located at an angle to the receptacle 41 and serves to encompass the vertical post 2.

The rear clamp 30 comprises a U-shaped receptacle 31 which can be pushed around the rear post 2. In order to secure the quick fastening device against lifting towards the front, a latching receptacle 32 is formed on the rear clamp 30, which comprises a lower web 35 which grips under the bent end sections 4 of the rod 3. An upper web 33 is furthermore formed, on which a detent 34 is provided on the side facing the web 35. Upon pushing the clamps 30 onto the bent end section 4, the web 33 is bent upwards by the detent 34 until the detent 34 grips behind the bent end section and thereby secures the quick fastening device against withdrawal. In order to reliably prevent withdrawal due to high pull-out forces, the detent 34 can be the same or greater than half the diameter of the rod 3 in its extension to the web 35.

FIGS. 6A and 6B show a modified embodiment of the clamps 40 and 30′ where the front clamp 40 corresponds to the exemplary embodiment of FIG. 5A. Only the rear clamp 30′ is modified such that the latching means is not disposed on the receptacle for fixing of the bent end section 4 but on a U-shaped receptacle 31′ for fixing the clamps 30′ on the vertical post 2. For this purpose a wall of the leg is divided on the U-shaped receptacle 31′ and a detent 34′ is formed on the inwardly directed side, which is disposed bendably on the receptacle 31′ so that when inserting the post 2 into the receptacle 31′, the detent 34′ grips behind the post 2. An opposite leg 35′ of the receptacle 31′ serves as a counter bearing for the detent 34′. A second U-shaped receptacle 32′ for the bent end section 4 of the rod 3 is formed perpendicular to the receptacle 31′.

FIGS. 7A to 7C show another embodiment of a quick fastening device by which means the one guide rail 6 of a pull-out guide is mounted on a side grid 1. The quick fastening device comprises a front clamp 50 and a rear clamp 60 which are fixed on the guide rail 6 or a strip 7 connected to the guide rail 6.

As can be identified from FIGS. 8A and 8B, the front clamp 50 comprises a U-shaped receptacle 51 for encompassing the vertical post 2 of the side grid 1. Another U-shaped receptacle 53 is formed at an angle to the receptacle 51, by which means a bent end section 4 of the rod 3 is encompassed. Another U-shaped receptacle 52 is formed integrally with the U-shaped receptacle 53, which is configured to encompass a section of the rod 3 extending in the longitudinal direction. The U-shaped receptacles 51, 52 and 53 are each disposed at right angles to one another so that a transfer of forces is possible in five directions without pulling away the clamps 50 from the side grid 1.

The rear clamp 60 also comprises a U-shaped receptacle 61 which serves to encompass the rod 3 in the area of the longitudinal extension. A latching web 62 is formed adjacent to the U-shaped receptacle 61, which has a downward-pointing detent 63. When pushing on the clamps 50 and 60, the web 62 is bent upwards by a bent end section 4 of a rod 3 and the detent 63 engages behind the bent end section 4 so that the quick fastening device is secured against pulling away to the front. The clamp 60 further comprises a stop web 64 which grips behind the vertical post 2 in order to avoid pulling away towards the interior in the rear area.

FIGS. 9A and 9B show a modified embodiment of two clamps 50 and 60′, with the clamp 50 corresponding to the preceding exemplary embodiment. A U-shaped receptacle 61′ that encompasses the rod 3 is formed at the rear clamp 60′. Unlike in the preceding exemplary embodiment, the latching means do not act on the bent end section 4 but on the post 2. For this purpose a stop web 64′ is formed at the end on the clamp 60′ which grips behind the post 2 on the side facing away from the interior. A web 62′ is formed adjacently parallel to the stop web 64′, on which a latching projection 63′ is formed which grips behind the post 2 when pushing on the clamp 60′.

FIGS. 10A to 10C show an embodiment of a quick fastening device for fastening a guide rail 6 of a pull-out guide on a side grid 1. The quick fastening device comprises a front clamp 70 and a rear clamp 80 which are fixed on the guide rail 6 or a strip connected to the guide rail 6.

As can be seen from FIGS. 11A and 11B, the front clamp 70 comprises a U-shaped receptacle 71 open at the bottom for encompassing an end section 4 of a horizontal web 3. A vertical plate 72 is formed above the receptacle 71, which serves as a stop and can be placed on the vertical post 2. A downwardly directed resilient web 73 on which a latching projection 74 projects is formed integrally with the U-shaped receptacle 71.

The rear clamp 80 comprises a horizontally aligned U-shaped receptacle 81 which serves to encompass an end section 4 of a rod 3. A plate-shaped stop 82 is formed adjacent to the U-shaped receptacle 81, which can be placed on a vertical post 2. A curved web 83 is provided on the side opposite the stop 82, which web can be placed with its inside on the horizontal rod 3 in the area of the transition between the region of the longitudinal extension and the bent end section 4.

The clamps 70 and 80 are mounted by firstly pushing the rear clamp 80 onto the end section 4 so that the clamp 80 is disposed between the post 2 and the region of the longitudinal extension of the rod 3. The guide rail 6 is then pivoted downwards so that the U-shaped receptacle 71 is pushed from above onto the end section 4 and is engaged via the latching projection 74.

The present invention is not restricted to the exemplary embodiments shown. It is also possible to position the latching means and U-shaped receptacles at different points of the individual clamps and also combine the individual exemplary embodiments with one another.

The quick fastening device can optionally be assembled in the horizontal direction from inside or from the front but it is also possible to pivot the clamps onto the side grid 1 on a rod 3, a post 2 or an end section 4.

### REFERENCE LIST

1 Side grid
2 Post
3 Rods
4 Bent end section
5 Running rail
6 Guide rail
7 Strip
8 Middle rail
10 Clamp
12 Plate-shaped stop
13 Rod
14 Bent projection
15 Support
16 U-shaped receptacle
17 Plate-shaped stop
18 Plate
20 Clamp
20′ Clamp
21 Plate
22 Web
25 Projection
26 Slot
30 Rear clamp
30′ Rear clamp
31 U-shaped receptacle
31′ U-shaped receptacle
32 Latching receptacle
32′ U-shaped receptacle
33 Upper web
34 Detent
34′ Detent
35 Lower web
35′ Leg
40 Front clamp
50 Front clamp
51 U-shaped receptacle
52 U-shaped receptacle
53 U-shaped receptacle
60 Clamp
60′ Rear clamp
61 U-shaped receptacle
62 Latching web
62′ Web
63 Detent
63′ Latching projection
64 Stop web
64′ Stop web
70 Front clamp
71 U-shaped receptacle
72 Vertical plate
73 Resilient web
74 Latching projection
80 Rear clamp
81 U-shaped receptacle
82 Plate-shaped stop
83 Curved web

1. A quick fastening device for fastening a guide rail (6) to a horizontally extending rod (3) which comprises one bent end section (4) at each opposite side, which end sections are fixed to posts (2) of a grid-like side part (1), wherein at least one bent end section (4) is encompassed by a clamp (10, 20, 20′, 30, 30′, 40, 50, 60, 60′, 70, 80) connected to the guide rail (6), characterised in that a stop (12, 17, 17′, 31, 31′, 42, 51, 64, 64′, 72, 82) lying against a post (2) on the side facing the guide rail (6) is formed on at least one clamp (10, 20, 20′, 30, 30′, 40, 50, 60, 60′, 70, 80).

2. The quick fastening device according to claim 1, characterised in that a stop (12, 17, 17′, 31, 31′, 42, 51, 61, 61′, 72, 82) for abutting against a post (2) on the side facing the guide rail (6) is formed on both clamps (10, 20, 20′, 30, 30′, 40, 50, 60, 60′, 70, 80).

3. The quick fastening device according to claim 1 or 2, characterised in that the stop (12, 17, 17′, 72, 82) is formed in a plate shape.

4. The quick fastening device according to any one of claims 1 to 3, characterised in that the stop (31, 31′, 42, 51, 52, 53, 61, 61′) is formed on a U-shaped holder.

5. The quick fastening device according to any one of claims 1 to 4, characterised in that each clamp (10, 20, 20′, 30, 30′, 40, 50, 60, 60′, 80) is fixed on the bent end section (4) of the rod (3) by means of latching means (34, 34′, 63, 63′).

6. The quick fastening device according to any one of claims 1 to 5, characterised in that the latching means (34, 34′, 63, 63′, 73) are formed by bendable webs on a clamp (30, 30′,60, 60′, 70).

7. The quick fastening device according to any one of claims 1 to 6, characterised in that at least one clamp (30, 30′, 40, 50, 60, 60′) comprises two U-shaped receptacles disposed at an angle to one another.

8. The quick fastening device according to any one of claims 1 to 7, characterised in that both clamps (10, 20, 20′, 30, 30′, 40, 50, 60, 60′) are fixed on a strip (7) which is connected to the guide rail (6).

9. The quick fastening device according to any one of claims 1 to 7, characterised in that the clamps are formed integrally with the guide rail (6).

10. The quick fastening device according to any one of claims 1 to 9, characterised in that the guide rail is disposed at least partially above the rod (3).

11. The quick fastening device according to claim 6, characterised in that the latching means (34, 34′, 63, 63′, 73) encompass the rod (3) or the post (2) over more than half the diameter.

12. The quick fastening device according to claim 6, characterised in that a run-in slope is formed on the latching means (34, 34′, 63, 63′, 73) on its side facing away from the rod (3) or the post (2).

13. The quick fastening device according to any one of claims 1 to 12, characterised in that two U-shaped receptacles are provided, which encompass the end section (4) from behind in a claw-like manner and are engaged at the front by lowering on to the bent end section (4).
